(19) United States
(12) Patent Application Publication
(10) Pub. No.: US 2026/0003489 A1
(43) Pub. Date: Jan. 1, 2026

(54) SYSTEM AND METHOD TO CAPTURE FULL PAGE SCREENSHOT

(71) Applicant: BrowserStack Limited, Dublin 2 (IE)

(72) Inventors: Pankaj Yadav, Haryana (IN); Pradum Kumar, Bihar (IN); Ninad Sheth, Thane (West) (IN); Akshay Minocha, Karnataka (IN)

(21) Appl. No.: 18/754,674

(22) Filed: Jun. 26, 2024

(51) Int. Cl. G06F 3/0485

(52) U.S. Cl. CPC G06F 3/0485

(57) ABSTRACT

A system including a processor is configured to perform operations to capture a full-page screenshot of an application page. The operations of the processor include to initially capture a screenshot of a subject application page, identify child elements present inside a scrollview, and detect last visible child element that is marked as an anchor element. A subsequent screenshot is captured keeping the anchor element as a previous anchor element. The processor calculates each height of header and footer of the subsequent screenshot and each height is cropped from the subsequent screenshot, performs a scroll depending on a height and location of the scroll view, reviews location of previous anchor element after the scroll is completed, and identifies whether the previous anchor element is the same as the subsequent anchor element and whether location of the subsequent anchor element is not updated, which marks end of the complete screenshot.

### TECHNICAL FIELD

The present invention relates to a field of capturing image data, more specifically, to capture a full-page screenshot based on image elements that are available on scroll view of an application page.

### BACKGROUND

Background description includes information that may be useful in understanding the present invention. It is not an admission that any of the information provided herein is prior art or relevant to the presently disclosed invention, or that any publication specifically or implicitly referenced is prior art.

Capturing full-page screenshots can indeed be a challenge, especially when dealing with mobile applications of varying lengths and dynamic content. Users are sometimes forced to manually scroll and take multiple screenshots to capture full-page screenshots, or the users must invest more time to engage in a single activity. It is also impossible to accurately measure full page height and determine how many complete scrolls that would be required to capture a full-page screenshot, as it is difficult to get information regarding y-coordinate dimensions with respect to total height. Therefore, in order to capture a full-page screenshot of an application page on a mobile devices, users find it difficult to capture total height of the app screen, to scroll to particular location, and to scroll by a given amount of pixels.

Most common prior art methods aimed at capturing full-page screenshots of application pages use scrollable offset to determine how much to scroll and gestures to scroll, but however, scrollable offset doesn't exist every time for a scrollview and as a result the user may not get full-page screenshot even if the app is scrollable. Furthermore, gestures are indeterministic so it won't be pixel perfect. Also, cases for dynamically loaded elements will fail here since the offset is pre-calculated. Yet another approach involves usage of native full-page screenshot. Here, native full-page SS present in android is used. The android version support is dependent on manufactures along with frontend interactions. However, it is not workable with some manufacturers. Any changes in UI for newer versions/devices may break the fundamental logic that may be used. Furthermore, the native full-page screenshot only works for certain browsers, and not for all the applications.

Therefore, there is a need for a system and method to capture hassle free full-page screenshot based on image elements that are available on scroll view of an application page.

### SUMMARY OF THE INVENTION

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

As used herein:
The term “scrollview” refers to a layout of mobile apps that is capable of scrolling its content. A scrollview can define many views inside it.
The term “scrollable offset” refers to an attribute of scrollview which gives the amount of pixels that can be scrolled more.
The term “Appium” refers to an open-source, mobile automation testing tool that is used to automate mobile applications. Appium provides various functions to interact with mobile app for automated testing.
The term “gestures” refer to the touch events that perform the actions on a mobile device similar to how a human would do, for example, long press, double click, swipe, scroll, etc.
The term “anchor element” refers to a reference element fetched from mobile apps page source that is used to determine header, footer heights, and amount of pixels scrolled.
The term “tile” refers to a single screenshot.
The term “cropping of tiles” refers to header and footer heights that are cropped from a single tile to get results which are stitched together to get a complete full page.

In the technique disclosed here, the approach doesn't rely on predefined attribute and the screenshot is taken even if the attribute is absent. Here, dynamically loaded apps will also work as we calculate anchor elements in every iteration. This will help in retrieving a pixel perfect full-page screenshot.

A system and associated method that involves a processor is disclosed herein, which is configured to perform operations to capture a full-page screenshot of an application page on an application window. This system and associated method address the above-mentioned disadvantages and drawbacks in the background section of this disclosure. The operations of the processor include to initially capture a screenshot of a subject application page. The processor identifies child elements present inside a scrollview of the application page, where child elements are portions of images of the application page that are observed on the application window. In response to identification of child elements, the processor detects last visible child element that is marked as an anchor element. A subsequent screenshot is captured keeping the anchor element as a previous anchor element which will be higher than a subsequent anchor element in the subsequent screenshot. The processor calculates each height of header and footer of the subsequent screenshot based on current location of previously selected anchor element and location of the subsequent anchor element, where each height of the header and the footer is cropped from the subsequent screenshot. The processor performs a scroll depending on a height and location of the scroll view of the application page. The processor reviews location of previous anchor element after the scroll is completed, where difference based on the scroll provides information regarding amount of pixels that were scrolled. Finally, the processor identifies whether the previous anchor element is the same as the subsequent anchor element and whether location of the subsequent anchor element is not updated, which marks end of the complete screenshot.

In an embodiment, the method and system further comprises validation of the anchor element, after marking the anchor element, where the validation is performed by analysing presence of the anchor element based on boundary and positional orientation with respect to the scrollview. In an embodiment, the validation of the anchor element based on boundary and positional orientation with respect to the scrollview includes that: the anchor element is not outside bounds of the scrollview, and the anchor element is not a horizontal or a vertical scrollbar.

In an embodiment, the calculation of the height of the header and the footer of the screenshot to display a complete full-page screenshot depends on the header and the footer. The header is considered as y-coordinate of the previous anchor element and the footer is considered as y-coordinate of the subsequent anchor element. In an embodiment, users are allowed to choose scrollview when multiple scrollviews are present, where each user is allowed to provide a path of a scrollable view that the user wants to select. In an embodiment, users are allowed to choose the scrollview when multiple scrollviews are present, where each user is allowed to provide an ID of the scrollable view that they want to select.

In an embodiment, users are allowed to provide height of complete screenshot by entering the number of full application page scrolls, where one full application page scroll equals to height of complete application page. In an embodiment, if the user is not providing any input then a first scrollview of the application page is taken into consideration as default, where the first scrollable portion is validated to be at least 90% of screen-width and 30% of application height of display. In an embodiment, the application window is parsed to find a first valid scrollview, wherein the processor checks whether: number of the child elements is greater than 1, and if the number of child elements is less than or equal to 1, then the first valid scrollview is considered as a flutter scrollview. Here, the flutter scrollview remains on same level as the child elements, and the first valid scrollview is corrected accordingly.

These and other objects, embodiments and advantages of the present invention will become readily apparent to those skilled in the art from the following detailed description of the embodiments having reference to the attached figures, the invention not being limited to any particular embodiments disclosed.

### BRIEF DESCRIPTION OF FIGURES

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting its scope, for the subject matter may admit to other equally effective embodiments.

FIG. 1A exemplarily illustrates a schematic flow of the steps that are involved in the system and associated method that captures a full-page screenshot of an application page on an application window, as an example embodiment of the present disclosure.

FIG. 1B exemplarily illustrates a real-world example embodiment to illustrate the steps that are involved in the system and associated method that captures a full-page screenshot of an application page on an application window.

FIG. 1C exemplarily illustrates a full-page screenshot because of the methods adopted in FIGS. 1A and 1B, as an example embodiment of the present disclosure.

FIG. 2 exemplarily illustrates a flowchart associated with the method and system disclosed in FIGS. 1A-1C, as an example embodiment of the present disclosure.

FIG. 3 illustrates a schematic drawing of the scrollview content to indicate finding and parsing of the scrollview, as an example embodiment of the present disclosure.

FIG. 4 is a block diagram that illustrates a system that captures a full-page screenshot of an application page on an application window, can be implemented.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

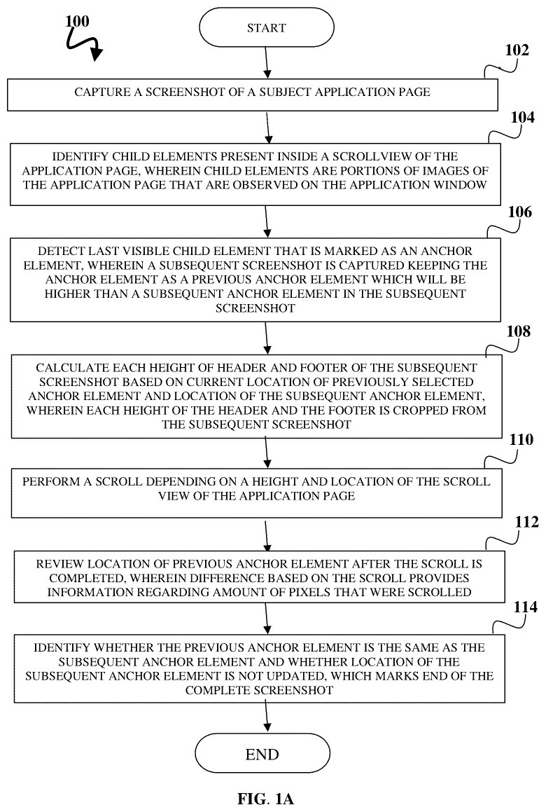

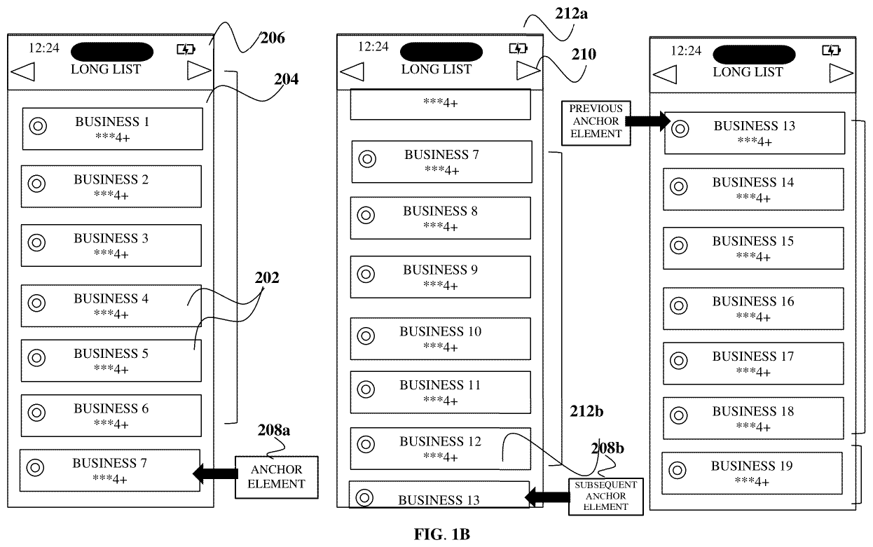

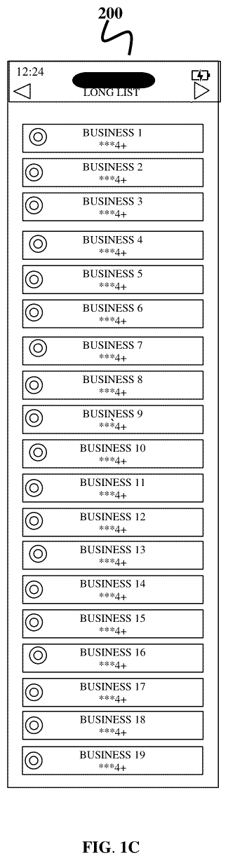

Referring to FIGS. 1A-IC, FIG. 1A exemplarily illustrates a schematic flow of the steps that are involved in the system 100 and associated method that captures a full-page screenshot 200 of an application page 204 on an application window 206, as an example embodiment of the present disclosure. FIG. 1B exemplarily illustrates a real-world example embodiment to illustrate the steps that are involved in the system 100 and associated method that captures a full-page screenshot 200 of an application page on an application window 206. FIG. 1C exemplarily illustrates a full-page screenshot 200 because of the methods adopted in FIGS. 1A-IC, as an example embodiment of the present disclosure.

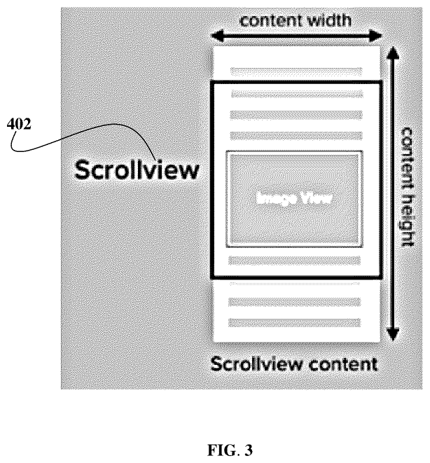

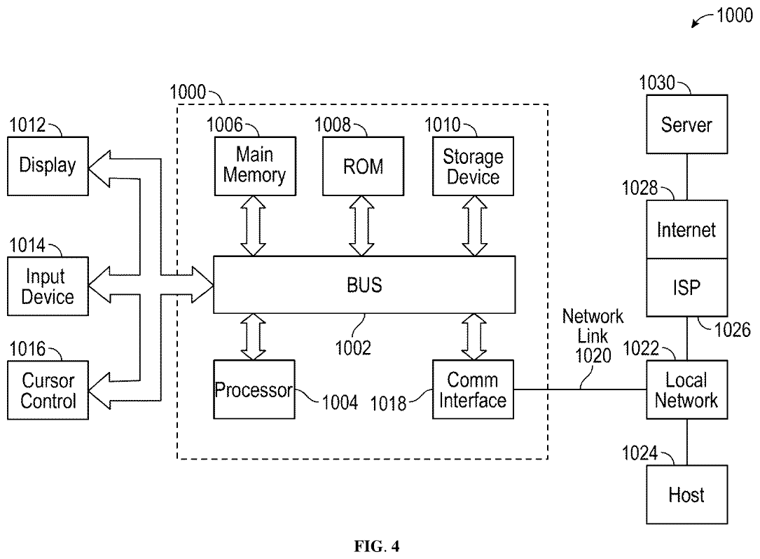

The operations of the system 100 and associated method include to initially capture 102, via the processor 1004 (shown in FIG. 4), a screenshot 204a of a subject application page 204. The processor 1004 is configured to perform operations to capture a full-page screenshot 200 of an application page 204 on an application window 206. The processor 1004 identifies 104 child elements 202 present inside a scrollview 402 (as shown in FIG. 3) of the application page 204, where child elements 202 are portions of images of the application page 204 that are observed on the application window 206. The child elements 202 are, for example, image portions or text portions that can be identified from the application page 204 or a web page. In response to identification of child elements 202, the processor 1004 detects 106 last visible child element 202 that is marked as an anchor element 208a. A subsequent screenshot 210 is captured keeping the anchor element 208a as a previous anchor element which will be higher than a subsequent anchor element 208b in the subsequent screenshot 210.

The processor 1004 calculates 108 each height of header 212a and footer 212b of the subsequent screenshot 210 based on current location of previously selected anchor element 208a and location of the subsequent anchor element 208b, where each height of the header 212a and the footer 212b is cropped from the subsequent screenshot 210. The processor 1004 performs 110 a scroll depending on a height and location of the scrollview 402 of the application page 204. The processor 1004 reviews 112 location of previous anchor element 208a after the scroll is completed, where difference based on the scroll provides information regarding amount of pixels that were scrolled. Finally, the processor 1004 identifies 114 whether the previous anchor element 208a is the same as the subsequent anchor element 208b and whether location of the subsequent anchor element 208b is not updated, which marks end of the full-page screenshot 200.

The method and system 100 further comprise validation of the anchor element 208a, after marking the anchor element 208a, where the validation is performed by analyzing presence of the anchor element 208a based on boundary and positional orientation with respect to the scrollview 402. The system verifies whether the anchor element 208a within a predefined boundaries that are originally identified and validates the sequential number of the anchor element 208a, keeping track of the logic to identify the last anchor element 208a. The validation of the anchor element 208a based on boundary and positional orientation with respect to the scrollview 402 includes that: (1) the anchor element 208a is not outside bounds of the scrollview 402, and (2) the anchor element 208a is not a horizontal or a vertical scrollbar. The system performs these checks (1) and (2) to ensure that the stitching process is seamless, since the presence of anchor element 208a outside the bounds of the scrollview 402 allows the logic to pause, revert and identify another anchor element 208a that's within the boundary. Furthermore, the system prevents the anchor element 208a from being detected as a horizontal or a vertical scrollbar, which hampers the stitching process of the original full application page 204.

The calculation of the height of the header 212a and the footer 212b of the screenshot 204a to display a complete full-page screenshot 200 depends on the header 212a and the footer 212b. The header 212a is considered as y-coordinate of the previous anchor element 208a and the footer 212b is considered as y-coordinate of the subsequent anchor element 208b. The height of the header 212a and the footer 212b of the screenshot 204a in subsequent screenshots (or all the screen shots between the first and last screenshot) after the first and the last screenshot are identified and removed to generate a smooth full-page screenshot 200, as shown in FIG. 1C. The users are allowed to choose scrollview 402 when multiple scrollviews 402 are present, where each user is allowed to provide a path of a scrollable view that the user wants to select. The users are allowed to choose the scrollview 402 when multiple scrollviews 402 are present, where each user is allowed to provide an ID of the scrollable view that they want to select. The users are allowed to provide height of full-page screenshot 200 by entering the number of full application page scrolls, where one full application page scroll equals to height of complete application page 204.

If the user is not providing any input then a first scrollview 402 of the application page is taken into consideration as default, where a first scrollable portion is validated to be at least 90% of screen-width and 30% of application height of display. The application window is parsed to find a first valid scrollview 402, wherein the processor 1004 checks whether: number of the child elements 202 is greater than 1, and if the number of child elements 202 is less than or equal to 1, then the first valid scrollview 402 is considered as a flutter scrollview 402. Here, the flutter scrollview 402 remains on same level as the child elements 202, and the first valid scrollview 402 is corrected accordingly.

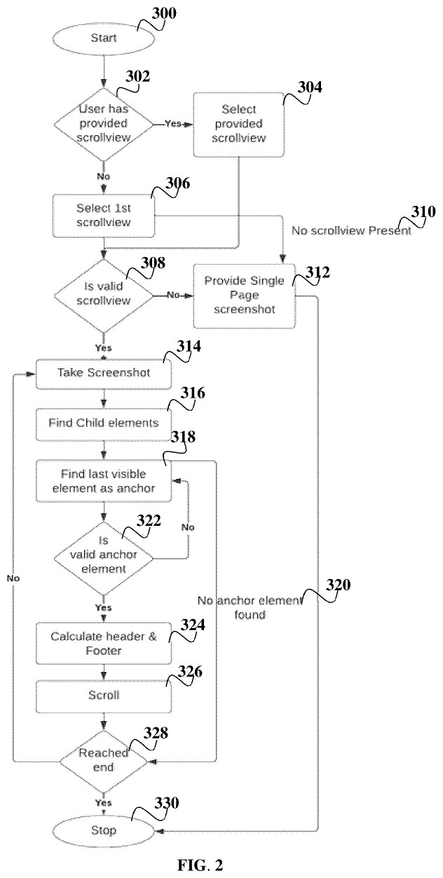

FIG. 2 exemplarily illustrates a flowchart associated with the method and system 100 disclosed in FIGS. 1A and 1B, as an example embodiment of the present disclosure. As shown in the flowchart, at 300, the method steps based on the system 100 start. At 302, user provides a scrollview 402. At 304, the scrollview 402 is selected if indeed (Yes) the user has provided it. However, at 306, if the user has not (No) provided the scrollview 402, then the system 100 selects the first scrollview 402. At 310, if there is no scrollview 402 present then, at 312, the system 100 captures and provides a single page screenshot. At 308, a check is performed to validate whether the scrollview 402 is valid. Similarly, if the scrollview 402 is not (No) valid, then at 312, the system 100 again captures and provides a single page screenshot. If the scrollview 402 is indeed valid at 308, then at 314, the system 100 takes a screenshot. At 316, child elements 202 are identified or found.

At 318, the last visible anchor element 204a is checked and if the last visible anchor element 204a is not found, then at 320, the steps reach the end point. However, if the last visible anchor element 204a is found, then at 322, it is checked whether the last visible anchor element 204a is a valid anchor element 204a. If the last visible anchor element 204a is not (No) a valid anchor element 204a, then the system 100 return to step 318 to find the last visible anchor element 204a. If the last visible anchor element 204a is indeed a valid anchor element 204a, then at 324, the header and footer heights are calculated. At 326, a scroll is performed and at 328, the steps reach the end point and stops at 330 to retrieve a full-page screenshot 200. If it is not the end point at 328, then the system 100 returns to step 314 to take a screenshot again to continue the subsequent steps for validation and identification of the last valid anchor element 204a.

FIG. 3 illustrates a schematic drawing of the scrollview 402 content to indicate finding and parsing of the scrollview 402, as an example embodiment of the present disclosure. In the system 100 and method as disclosed, a process or logic of stitching is adopted where a first tile (or first screenshot) includes status bar along with content up till the anchor element 204a and the last tile (or last screenshot) crop top offset includes content below previous anchor element 204a including navigation bar.

In the stitching approach,
It was found that all gestures available in a variety of operating systems, for example, Android™ and iOS, were inaccurate in terms of scrolling area depending on apps/device, therefore the method is not completely based on gestures to scroll correctly.
Since the scrollable element is available, the next step is to find out the child elements 202 of the scrollable element, which is used to scroll, crop, and stitch to retrieve a full-page screenshot 200.
When page source is accessed on a mobile, the entire page source is not received or returned, which indicates presence of multiple other child elements 202 that get populated as a user scrolls down.
There are also cases when views are not present in child elements 202 but on the same level as scroll elements (Flutter iOS apps), so this aspect also needs consideration.

### Finding Scrollview

1. Both Android™ and iOS have scrollable views which are used to create scrollable sections of lists, cards, text, etc.
2. The users are enabled to choose scrollview 402 when multiple scrollviews 402 are present via:
   a) scrollableXpath user can provide XPath of the scrollable view they want to select, and
   b) scrollableId user can provide ID of the scrollable view they want to select.
3. Users can provide numOfTiles in options to specify how many devices heights need to be captured, Max is set to 10.
4. By default we will consider 1st scrollable that we find by using driver.findElement(By.xpath(//*[@scrollable=‘true’])); if nothing is provided by user
   a) Scrollview 402 is validated to be at least 90% of screen width and 30% of screen height
   b) Parse through scrollable views to find first valid scrollview 402:
      (1) child_elements.length>1
      (2) child_elements.length<=1 then it is flutter scrollview 402 and it will be on same same level as its child elements 202. Ruby extensible Markup Language (REXML) is used to get the correct scrollable view here.
5. Post step 4, scrollable view is made available that is either provided by user or a default scrollable view, then a single page screenshot is taken, if no scrollview 402 is found.

### Parsing Scrollview

1. Finding child elements 202 using: driver.find_child_elements(scrollable_view, ‘xpath’, ‘//*’)
2. Once the list of the elements is identified, the last visible anchor element 204a is also detected along with its location using attributes.
3. The anchor element 204a is validated by checking its size and location:
   anchor_element y location should be after scrollable_view y location
   anchor_element end location should be before or equal to scrollable_view end location
4. For 1^{st} tile it is set as header_height=0, for last tile it is set as footer_height=0 and calculate both for in-between tiles depending on anchor element's 204a location.
5. A scroll is performed (not complete 80% of scrollview 402 height, and this is due to the fact that in some cases gesture scroll is more than mentioned). Post scroll is completed a recheck is performed for the location of anchor element 204a which provides a measure of the scroll.
6. The element is marked as previous_ancor_element and child_nodes is checked to find next anchor element 204b.

### Finishing Parsing

1. If the previous_ancor_element is the same as new_ancor_element and its location is not updated, then the sequence has reached end and the operation is stopped.
2. If max pixel limit has been reached then loop is broken and the last tile's footer is updated to 0.

The working involves:
1. Scrollview 402 having list of items. Each item is same size.
2. Long scrollview 402 with textviews and images
3. Scrollview 402 on same level as its elements (iOS flutter apps)
4. Scrollview 402 linear layout many child elements 202
5. Application having header and footer
6. Multiple scrollviews 402
   a) We consider 1^{st} scrollview 402 only in this case.
7. When scrollview 402 expands upwards when scrolled.
8. Infinite scroll:
   a) For this a limit is set on number of scrolls, for example, 15 scrolls which will be effective 12 scrolls.
   b) Since the gestures are observed as inaccurate, different final lengths are detected every time. A limit on final length is determined accordingly its cropped down to, for example, within a range of 10-15k pixels to get final correct output.
9. Partial vertical scrollviews 402: width of the scrollview 402 is checked which is at least 90% of device width. This is because if a less wider scrollview 402 is considered, then a repetitive static text is observed on the 2nd half of the application which is not scrolling.

### Other Cases and What we Will Show as Output:

1. If user triggers full-page screenshot 200 but no scrollable view is located: output single page screenshot.
2. Scrollview 402 has only 1 long text view: since anchor element 204a will be same here and its location is also not update, therefore it's not possible to take full-page screenshot 200, and only a single page screenshot can be provided.
3. Scrollview 402 has a long element in between.
   a) If 1^{st} screen has that long element, then show single-page screenshot.
   b) If long element comes after a few scrolls then only show take screenshot till that element.

### Example Implementation Mechanism—Hardware Overview:

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

For example, FIG. 4 is a block diagram that illustrates a computer system 1000 that captures a full-page screenshot 200 of an application page 204 on an application window 206, can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted, or received in video conferencing architectures. Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions. Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media. Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### Examples

It will be appreciated that the present disclosure may include any one and up to all of the following examples.
Example 1: A system comprising a processor, the processor configured to perform operations to capture a full-page screenshot of an application page on an application window, wherein each operation includes to: capture a screenshot of a subject application page; identify child elements present inside a scrollview of the application page, wherein child elements are portions of images of the application page that are observed on the application window; in response to identification of child elements, detect last visible child element that is marked as an anchor element, wherein a subsequent screenshot is captured keeping the anchor element as a previous anchor element which will be higher than a subsequent anchor element in the subsequent screenshot; calculate each height of header and footer of the subsequent screenshot based on current location of previously selected anchor element and location of the subsequent anchor element, wherein each height of the header and the footer is cropped from the subsequent screenshot; perform a scroll depending on a height and location of the scroll view of the application page; review location of previous anchor element after the scroll is completed, wherein difference based on the scroll provides information regarding amount of pixels that were scrolled; and identify whether the previous anchor element is the same as the subsequent anchor element and whether location of the subsequent anchor element is not updated, which marks end of the full-page screenshot.
Example 2: The system of example 1, further comprises validation of the anchor element, after marking the anchor element, wherein the validation is performed by analyzing presence of the anchor element based on boundary and positional orientation with respect to the scrollview.
Example 3: The system of some or all of Examples 1 and 2, wherein the validation of the anchor element based on boundary and positional orientation with respect to the scrollview includes that: the anchor element is not outside bounds of the scrollview, and the anchor element is not a horizontal or a vertical scrollbar.
Example 4: The system of some or all of Examples 1-3, wherein the calculation of the height of the header and the footer of the screenshot to display a complete full-page screenshot depends on the header and the footer, wherein the header is considered as y-coordinate of the previous anchor element and the footer is considered as y-coordinate of the subsequent anchor element.
Example 5: The system of some or all of Examples 1-4, wherein users are allowed to choose scrollview when multiple scrollviews are present, wherein each user is allowed to provide a path of a scrollable view that the user wants to select.
Example 6: The system of some or all of Examples 1-5, wherein users are allowed to choose the scrollview when multiple scrollviews are present, wherein each user is allowed to provide an ID of the scrollable view that they want to select.
Example 7: The system of some or all of Examples 1-6, wherein users are allowed to provide height of full-page screenshot by entering the number of full application page scrolls, wherein one full application page scroll equals to height of complete application page.
Example 8: The system of some or all of Examples 1-7, wherein if the user is not providing any input then a first scrollview of the application page is taken into consideration as default, wherein the first scrollable portion is validated to be at least 90% of screen-width and 30% of application height of display.
Example 9: The system of some or all of Examples 1-8, wherein the application window is parsed to find a first valid scrollview, wherein the processor checks whether: number of the child elements is greater than 1; and if the number of child elements is less than or equal to 1, then the first valid scrollview is considered as a flutter scrollview, which remains on same level as the child elements, and wherein the first valid scrollview is corrected accordingly.
Example 10: A method to perform operations using a processor to capture a full-page screenshot of an application page on an application window, wherein each operation comprising: capturing a screenshot of a subject application page; identifying child elements present inside a scrollview of the application page, wherein child elements are portions of images of the application page that are observed on the application window; in response to identification of child elements, detecting last visible child element that is marked as an anchor element, wherein a subsequent screenshot is captured keeping the anchor element as a previous anchor element which will be higher than a subsequent anchor element in the subsequent screenshot; calculating each height of header and footer of the subsequent screenshot based on current location of previously selected anchor element and location of the subsequent anchor element, wherein each height of the header and the footer is cropped from the subsequent screenshot; performing a scroll depending on a height and location of the scroll view of the application page; reviewing location of previous anchor element after the scroll is completed, wherein difference based on the scroll provides information regarding amount of pixels that were scrolled; and identifying whether the previous anchor element is the same as the subsequent anchor element and whether location of the subsequent anchor element is not updated, which marks end of the full-page screenshot.
Example 11: The method of example 10, further comprising validating the anchor element, after marking the anchor element, wherein the validation is performed by analysing presence of the anchor element based on boundary and positional orientation with respect to the scrollview.
Example 12: The method of some or all of Examples 10 and 11, wherein the validation of the anchor element based on boundary and positional orientation with respect to the scrollview includes that: the anchor element is not outside bounds of the scrollview, and the anchor element is not a horizontal or a vertical scrollbar.
Example 13: The method of some or all of Examples 10-12, wherein the calculation of the height of the header and the footer of the screenshot to display a complete full-page screenshot depends on the header and the footer, wherein the header is considered as y-coordinate of the previous anchor element and the footer is considered as y-coordinate of the subsequent anchor element.
Example 14: The method of some or all of Examples 10-13, wherein users are allowed to choose scrollview when multiple scrollviews are present, wherein each user is allowed to provide a path of a scrollable view that the user wants to select.
Example 15: The method of some or all of Examples 10-14, wherein users are allowed to choose the scrollview when multiple scrollviews are present, wherein each user is allowed to provide an ID of the scrollable view that they want to select.
Example 16: The method of some or all of Examples 10-15, wherein users are allowed to provide height of full-page screenshot by entering the number of full application page scrolls, wherein one full application page scroll equals to height of complete application page.
Example 17: The method of some or all of Examples 10-16, wherein if the user is not providing any input then a first scrollview of the application page is taken into consideration as default, wherein the first scrollable portion is validated to be at least 90% of screen-width and 30% of application height of display.
Example 18: The method of some or all of Examples 10-17, wherein the application window is parsed to find a first valid scrollview, wherein the processor checks whether: number of the child elements is greater than 1; and if the number of child elements is less than or equal to 1, then the first valid scrollview is considered as a flutter scrollview, which remains on same level as the child elements, and wherein the first valid scrollview is corrected accordingly.
Example 19: A non-transitory computer storage that stores executable program instructions that, when executed by one or more computing devices, configure the one or more computing devices to perform operations to capture a full-page screenshot 200 of an application page on an application window, the operations comprising: capturing a screenshot of a subject application page; identifying child elements present inside a scrollview of the application page, wherein child elements are portions of images of the application page that are observed on the application window; in response to identification of child elements, detecting last visible child element that is marked as an anchor element, wherein a subsequent screenshot is captured keeping the anchor element as a previous anchor element which will be higher than a subsequent anchor element in the subsequent screenshot; calculating each height of header and footer of the subsequent screenshot based on current location of previously selected anchor element and location of the subsequent anchor element, wherein each height of the header and the footer is cropped from the subsequent screenshot; performing a scroll depending on a height and location of the scroll view of the application page; reviewing location of previous anchor element after the scroll is completed, wherein difference based on the scroll provides information regarding amount of pixels that were scrolled; and identifying whether the previous anchor element is the same as the subsequent anchor element and whether location of the subsequent anchor element is not updated, which marks end of the full-page screenshot.

It will be understood that each block of the block diagrams can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation of the scope of the invention.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

We claim:

1. A system comprising a processor, the processor configured to perform operations to capture a full-page screenshot of an application page on an application window, wherein each operation includes to:
capture a screenshot of a subject application page;
identify child elements present inside a scrollview of the application page, wherein child elements are portions of images of the application page that are observed on the application window;
in response to identification of child elements, detect last visible child element that is marked as an anchor element, wherein a subsequent screenshot is captured keeping the anchor element as a previous anchor element which will be higher than a subsequent anchor element in the subsequent screenshot;
calculate each height of header and footer of the subsequent screenshot based on current location of previously selected anchor element and location of the subsequent anchor element, wherein each height of the header and the footer is cropped from the subsequent screenshot;
perform a scroll depending on a height and location of the scroll view of the application page;
review location of previous anchor element after the scroll is completed, wherein difference based on the scroll provides information regarding amount of pixels that were scrolled; and
identify whether the previous anchor element is the same as the subsequent anchor element and whether location of the subsequent anchor element is not updated, which marks end of the full-page screenshot.

2. The system as claimed in claim 1, further comprises validation of the anchor element, after marking the anchor element, wherein the validation is performed by analysing presence of the anchor element based on boundary and positional orientation with respect to the scrollview.

3. The system as claimed in claim 2, wherein the validation of the anchor element based on boundary and positional orientation with respect to the scrollview includes that:
the anchor element is not outside bounds of the scrollview, and
the anchor element is not a horizontal or a vertical scrollbar.

4. The system as claimed in claim 1, wherein the calculation of the height of the header and the footer of the screenshot to display a complete full-page screenshot depends on the header and the footer, wherein the header is considered as y-coordinate of the previous anchor element and the footer is considered as y-coordinate of the subsequent anchor element.

5. The system as claimed in claim 1, wherein users are allowed to choose scrollview when multiple scrollviews are present, wherein each user is allowed to provide a path of a scrollable view that the user wants to select.

6. The system as claimed in claim 1, wherein users are allowed to choose the scrollview when multiple scrollviews are present, wherein each user is allowed to provide an ID of the scrollable view that they want to select.

7. The system as claimed in claim 6, wherein users are allowed to provide height of full-page screenshot by entering the number of full application page scrolls, wherein one full application page scroll equals to height of complete application page.

8. The system as claimed in claim 7, wherein if the user is not providing any input then a first scrollview of the application page is taken into consideration as default, wherein the first scrollable portion is validated to be at least 90% of screen-width and 30% of application height of display.

9. The system as claimed in claim 8, wherein the application window is parsed to find a first valid scrollview, wherein the processor checks whether:
number of the child elements is greater than 1; and
if the number of child elements is less than or equal to 1, then the first valid scrollview is considered as a flutter scrollview, which remains on same level as the child elements, and wherein the first valid scrollview is corrected accordingly.

10. A method to perform operations using a processor to capture a full-page screenshot of an application page on an application window, wherein each operation comprising:
capturing a screenshot of a subject application page;
identifying child elements present inside a scrollview of the application page, wherein child elements are portions of images of the application page that are observed on the application window;
in response to identification of child elements, detecting last visible child element that is marked as an anchor element, wherein a subsequent screenshot is captured keeping the anchor element as a previous anchor element which will be higher than a subsequent anchor element in the subsequent screenshot;
calculating each height of header and footer of the subsequent screenshot based on current location of previously selected anchor element and location of the subsequent anchor element, wherein each height of the header and the footer is cropped from the subsequent screenshot;
performing a scroll depending on a height and location of the scroll view of the application page;
reviewing location of previous anchor element after the scroll is completed, wherein difference based on the scroll provides information regarding amount of pixels that were scrolled; and
identifying whether the previous anchor element is the same as the subsequent anchor element and whether location of the subsequent anchor element is not updated, which marks end of the full-page screenshot.

11. The method as claimed in claim 10, further comprising validating the anchor element, after marking the anchor element, wherein the validation is performed by analysing presence of the anchor element based on boundary and positional orientation with respect to the scrollview.

12. The method as claimed in claim 11, wherein the validation of the anchor element based on boundary and positional orientation with respect to the scrollview includes that:
the anchor element is not outside bounds of the scrollview, and
the anchor element is not a horizontal or a vertical scrollbar.

13. The method as claimed in claim 10, wherein the calculation of the height of the header and the footer of the screenshot to display a complete full-page screenshot depends on the header and the footer, wherein the header is considered as y-coordinate of the previous anchor element and the footer is considered as y-coordinate of the subsequent anchor element.

14. The method as claimed in claim 10, wherein users are allowed to choose scrollview when multiple scrollviews are present, wherein each user is allowed to provide a path of a scrollable view that the user wants to select.

15. The method as claimed in claim 10, wherein users are allowed to choose the scrollview when multiple scrollviews are present, wherein each user is allowed to provide an ID of the scrollable view that they want to select.

16. The method as claimed in claim 15, wherein users are allowed to provide height of full-page screenshot by entering the number of full application page scrolls, wherein one full application page scroll equals to height of complete application page.

17. The method as claimed in claim 16, wherein if the user is not providing any input then a first scrollview of the application page is taken into consideration as default, wherein the first scrollable portion is validated to be at least 90% of screen-width and 30% of application height of display.

18. The method as claimed in claim 17, wherein the application window is parsed to find a first valid scrollview, wherein the processor checks whether:
number of the child elements is greater than 1; and
if the number of child elements is less than or equal to 1, then the first valid scrollview is considered as a flutter scrollview, which remains on same level as the child elements, and wherein the first valid scrollview is corrected accordingly.

19. A non-transitory computer storage that stores executable program instructions that, when executed by one or more computing devices, configure the one or more computing devices to perform operations to capture a full-page screenshot of an application page on an application window, the operations comprising:
capturing a screenshot of a subject application page;
identifying child elements present inside a scrollview of the application page, wherein child elements are portions of images of the application page that are observed on the application window;
in response to identification of child elements, detecting last visible child element that is marked as an anchor element, wherein a subsequent screenshot is captured keeping the anchor element as a previous anchor element which will be higher than a subsequent anchor element in the subsequent screenshot;
calculating each height of header and footer of the subsequent screenshot based on current location of previously selected anchor element and location of the subsequent anchor element, wherein each height of the header and the footer is cropped from the subsequent screenshot;
performing a scroll depending on a height and location of the scroll view of the application page;
reviewing location of previous anchor element after the scroll is completed, wherein difference based on the scroll provides information regarding amount of pixels that were scrolled; and
identifying whether the previous anchor element is the same as the subsequent anchor element and whether location of the subsequent anchor element is not updated, which marks end of the full-page screenshot.
